(19) United States
(12) Patent Application Publication
(10) Pub. No.: US 2016/0195761 A1
(43) Pub. Date: Jul. 7, 2016

(54) CURVED DISPLAY PANEL AND MANUFACTURING METHOD THEREOF

(71) Applicants: BOE TECHNOLOGY GROUP CO., LTD., Beijing (CN); BEIJING BOE DISPLAY TECHNOLOGY CO., LTD., Beijing (CN)

(72) Inventors: Shuai LIU, Beijing (CN); Zhichao LV, Beijing (CN); Guangdong SHI, Beijing (CN); Chenyang ZHANG, Beijing (CN)

(21) Appl. No.: 14/802,662

(22) Filed: Jul. 17, 2015

(30) Foreign Application Priority Data
Jan. 4, 2015 (CN) 201510002241.4

(51) Int. Cl. G02F 1/1335; G02F 1/1368; G02F 1/1362; G02F 1/1339

(52) U.S. Cl. CPC G02F 1/133514; G02F 1/13394; G02F 1/133512; G02F 1/1368; G02F 1/136286; G02F 1/133516; G02F 2001/133354

(57) ABSTRACT

The present invention provides a curved display panel and a manufacturing method thereof. The curved display panel comprises a first substrate and a second substrate which are aligned to form a cell, wherein a plurality of first spacers are arranged on the first substrate, a plurality of second spacer groups respectively corresponding to the first spacers are arranged on the second substrate, each of the second spacer groups includes at least one pair of second spacers, a gap is formed between each pair of second spacers, and each of the first spacers is engaged in the gap between the corresponding pair of second spacers so that accurate alignment between the first substrate and the second substrate is maintained.

### FIELD OF THE INVENTION

The present invention relates to the field of display technology, and particularly, to a curved display panel and a manufacturing method thereof.

### BACKGROUND OF THE INVENTION

With development of display technology, curved display devices have caused extensive concern in the field. Since the radian of the curved display panel in the curved display device is substantially consistent with the radian of retina of viewers, the viewer feels more comfortable when viewing the curved display device. However, there are many technology challenges in manufacturing process of the curved display panel, and the most important issue is to avoid problems of light leakage and color bias in the curved display panel.

The main reason causing light leakage and color bias in the curved display panel is that, when a display panel is curved into the curved display panel, the array substrate and the color filter substrate thereof are applied with different stresses, resulting in different deformation amounts of the array substrate and the color substrate. As such, a relative displacement occurs between the array substrate and the color filter substrate, and the array substrate and the color filter substrate are misaligned with each other, thus problems of light leakage and color bias will occur at the position of misalignment. FIG. 1 and FIG. 2 respectively show a plan view and a section view of a curved display panel of prior art, in which the array substrate and the color filter substrate are misaligned with each other, wherein the arrows indicate directions of stresses, and the dashed rectangle frames indicate misalignment regions 11. When a backlight source is installed, light leakage regions 12 are generated at the position corresponding to each misalignment region 11.

In order to solve above technical problems, a technical solution of prior art is to employ a color filter on array (COA) technology or a BM on array (BOA) technology, wherein a color filter and a black matrix are formed on the array substrate. In such manners, there is no need for alignment, thus the problems of light leakage and color bias caused by misalignment may be avoided. However, most of the existing manufacturers have not yet carried out COA or BOA technology, or corresponding ancillary transport and processing processes were not considered in the establishment of production lines, thus it is difficult to promote the realization of the technical solution employing COA or BOA technology.

### SUMMARY OF THE INVENTION

An object of the present invention is to provide a curved display panel and a manufacturing method thereof, in order to solve problems of light leakage and color bias in a curved display panel.

In order to achieve the above object, as a first aspect of the present invention, a curved display panel is provided, which comprises a first substrate and a second substrate which are aligned to form a cell, wherein a plurality of first spacers are arranged on the first substrate, a plurality of second spacer groups respectively corresponding to the first spacers are arranged on the second substrate, each of the second spacer groups includes at least one pair of second spacers, a gap is formed between each pair of second spacers, and each of the first spacers is engaged in the gap between the corresponding pair of second spacers so that accurate alignment between the first substrate and the second substrate is maintained.

Preferably, the first substrate includes a first display region and a first vacant region located at periphery of the first display region, the second substrate includes a second display region and a second vacant region located at periphery of the second display region, wherein the first spacers are arranged in the first display region, and the second spacer groups are arranged in the second display region; and, a third ring spacer surrounding the first display region is arranged in the first vacant region, a fourth ring spacer surrounding the second display region is arranged in the second vacant region, a ring gap is formed in the fourth ring spacer, the third ring spacer is engaged in the ring gap of the fourth ring spacer so that accuracy alignment between the first substrate and the second substrate is maintained.

Preferably, the fourth ring spacer is configured to include two ring spacers, and the ring gap is formed between the two ring spacers of the fourth ring spacer.

Preferably, the first substrate is an array substrate, and positions of the first spacers correspond to positions of data lines on the array substrate, the second substrate is a color filter substrate, and positions of the second spacer groups correspond to positions of a black matrix on the color filter substrate.

Preferably, the first spacer and the second spacer have a longitudinal section of trapezoid shapes, an end of the first spacer close to a base substrate of the first substrate has a width larger than that of an end of the first spacer far away from the base substrate of the first substrate, an end of the second spacer close to a base substrate of the second substrate has a width larger than that of an end of the second spacer far away from the base substrate of the second substrate.

Preferably, the third ring spacer and the fourth ring spacer have a longitudinal section of trapezoid shapes, an end of the third ring spacer close to the base substrate of the first substrate has a width larger than that of an end of the third ring spacer far away from the base substrate of the first substrate, an end of the fourth ring spacer close to the base substrate of the second substrate has a width larger than that of an end of the fourth ring spacer far away from the base substrate of the second substrate.

As a second aspect of the present invention, a manufacturing method of a curved display panel is provided, comprising steps of:

preparing a first substrate, which includes:
providing a first base substrate;
arranging a plurality of first spacers on the first base substrate;

preparing a second substrate, which includes:
providing a second base substrate;
arranging a plurality of second spacer groups respectively corresponding to the first spacers on the second base substrate, wherein each of the second spacer groups includes at least one pair of second spacers, and a gap is formed between each pair of second spacers;

aligning the first substrate and the second substrate to form a cell, wherein each of the first spacers is engaged in the gap between the corresponding pair of second spacers, so that accurate alignment between the first substrate and the second substrate is maintained.

Preferably, the first substrate includes a first display region and a first vacant region located at periphery of the first display region, and the second substrate includes a second display region and a second vacant region located at periphery of the second display region, wherein the first spacers are arranged in the first display region, and the second spacer groups are arranged in the second display region;

the step of preparing a first substrate further includes:
arranging a third ring spacer at a position of the first base substrate corresponding to the first vacant region, wherein the third ring spacer surrounds the first display region;

the step of preparing a second substrate further includes:
arranging a fourth ring spacer at a position of the second base substrate corresponding to the second vacant region, wherein the fourth ring spacer surrounds the second display region, and a ring gap is formed in the fourth ring spacer;

the step of aligning the first substrate and the second substrate to form a cell further includes:
making the third ring spacer to be engaged in the ring gap of the fourth ring spacer, so that accuracy alignment between the first substrate and the second substrate is maintained.

Preferably, the first spacers, the second spacer groups, the third ring spacer and the fourth ring spacer are formed synchronously by using a half-tone mask process.

Preferably, the first substrate is an array substrate, and before arranging the plurality of the first spacers, the step of preparing a first substrate further includes:
forming an array of thin film transistors, gate lines and data lines, wherein the first spacers are arranged at positions corresponding to that of the data lines; the second substrate is a color filter substrate, and before arranging the plurality of the second spacer groups, the step of preparing a second substrate further includes:
forming a black matrix and a color filter layer on the second base substrate, wherein the second spacer groups are arranged at positions corresponding to that of the black matrix.

In the present invention, by arranging spacers engaged with each other respectively on the first substrate and the second substrate, an occurrence of relative displacement between the first substrate and the second substrate when the first substrate and the second substrate are curved is effectively avoided, thus problems of light leakage and color bias caused by misalignment between the first substrate and the second substrate are avoided, and display effect of the curved display panel is improved.

### BRIEF DESCRIPTION OF THE DRAWINGS

In order to understand the present invention better, accompanying drawings are used for further illustrating the present invention in conjunction with following specific implementations, and constitute a part of the specification, the present invention is not limited thereto, and in the drawings:

FIG. 1 shows a plan view of a curved display panel of prior art, in which an array substrate and a color filter substrate are misaligned with each other;

FIG. 2 shows a section view of the curved display panel of prior art, in which the array substrate and the color filter substrate are misaligned with each other;

FIG. 3 shows a section view of a curved display panel in an embodiment of the present invention;

FIG. 4 shows another section view of the curved display panel in the embodiment of the present invention;

FIG. 5 shows a plan view of a first substrate in the embodiment of the present invention;

FIG. 6 shows a section view of the first substrate in the embodiment of the present invention;

FIG. 7 shows a plan view of a second substrate in the embodiment of the present invention;

FIG. 8 shows a section view of the second substrate in the embodiment of the present invention;

FIG. 9 shows a section view of the first substrate and the second substrate after they are aligned to form a cell and before they are curved.

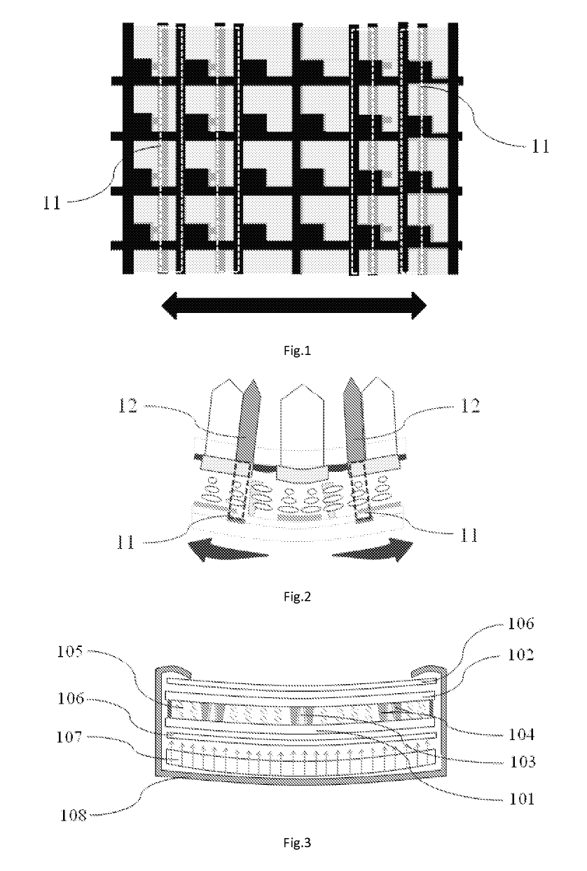

### REFERENCE SIGNS

11, misalignment region; 12, light leakage region; 101, first substrate; 102, second substrate; 103, first spacer; 104, second spacer; 105, liquid crystal; 106, polarizer; 107, curved back light; 108, metal frame; 109, third spacer; 110, fourth spacer; 111, gate line; 112, data line; 113, thin film transistor; 114, common electrode; 115, first base substrate; 116, black matrix; 117, color filter layer; 118, second base substrate; 201, first display region; 202, first vacant region; 203, second display region; 204, second vacant region.

### DETAILED DESCRIPTION OF EMBODIMENTS

Hereinafter, the specific implementations of the present invention will be described in detail in conjunction with the accompanying drawings. It should be understood that, the described specific implementations are only used for illustrating and explaining the present invention, and are not used for limiting the present invention.

The present invention provides a curved display panel as shown in FIG. 3. The curved display panel comprises a first substrate 101 and a second substrate 102 which are aligned to form a cell, wherein a plurality of first spacers 103 are arranged on the first substrate 101, a plurality of second spacer groups respectively corresponding to the first spacers 103 are arranged on the second substrate 102, each of the second spacer groups includes at least one pair of second spacers 104, a gap is formed between each pair of second spacers 104, and each of the first spacers 103 is engaged in the gap between the corresponding pair of second spacers 104 so that accurate alignment between the first substrate 101 and the second substrate 102 is maintained.

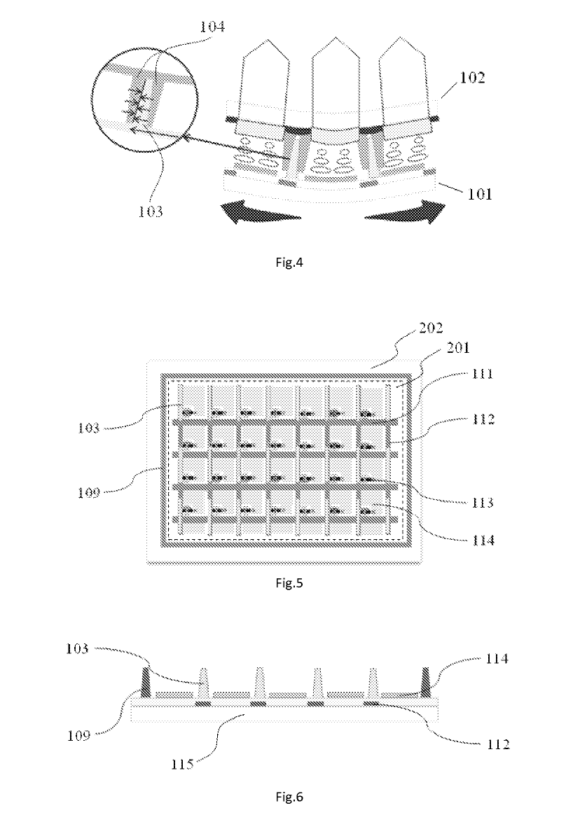

FIG. 4 shows a section view of the curved display panel in the embodiment of the present invention, wherein, thick arrows indicate directions of stresses. As seen from FIG. 4, in accordance with conception of the present invention, by arranging the first spacers 103 and the second spacers 104 on the first substrate 101 and the second substrate 102 respectively, each of the first spacers 103 and the corresponding pair of second spacers 104 are engaged with each other when the first substrate 101 and the second substrate 102 are curved after aligning to form a cell, so as to avoid an occurrence of relative displacement between the first substrate and the second substrate. Thus problems of light leakage and color bias caused by misalignment between the first substrate and the second substrate are effectively avoided, and display effect of the curved display panel is improved.

The specific configuration of the second spacer groups is not limited in the present invention. For example, each of the second spacer groups may include multiple pairs of second spacers 104, and the multiple pairs of second spacers 104 together form a gap capable of receiving the corresponding first spacer 103.

As shown in FIG. 3, liquid crystal 105 is filled between the first substrate 101 and the second substrate 102. When the curved display panel is installed in a curved display device, the curved display device further comprises polarizers 106 provided on opposite sides of the curved display panel, a curved backlight source 107 in cooperation with the curved display panel, and a metal frame 108 provided the most outside of the curved display device.

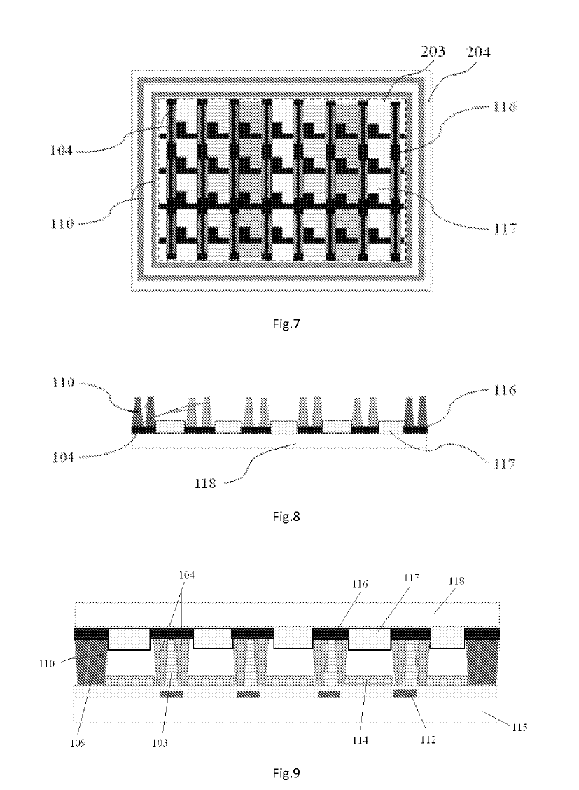

FIG. 5 shows a plan view of the first substrate in the embodiment of the present invention, and FIG. 6 shows a section view of the first substrate in the embodiment of the present invention. The first substrate 101 includes a first display region 201 and a first vacant region 202 located at periphery of the first display region 201. The first spacers 103 are arranged in the first display region 201. FIG. 7 shows a plan view of the second substrate in the embodiment of the present invention, and FIG. 8 shows a section view of the second substrate in the embodiment of the present invention. The second substrate 102 includes a second display region 203 and a second vacant region 204 located at periphery of the second display region 203. The second spacer groups (each including at least one pair of second spacers 104) are arranged in the second display region 203.

Preferably, a third ring spacer 109 that surrounds the first display region 201 is arranged in the first vacant region 202, and a fourth ring spacer 110 that surrounds the second display region 203 is arranged in the second vacant region 204. A ring gap is formed in the fourth ring spacer 110, and the third ring spacer 109 is engaged in the ring gap of the fourth ring spacer 110 so that accuracy alignment between the first substrate 101 and the second substrate 102 is maintained.

Preferably, the fourth ring spacer 110 is configured to include two ring spacers, and as shown in FIG. 7, the ring gap is formed between the two ring spacers. Alternatively, the fourth ring spacer 110 may be configured to include multiple segments of strip spacers, and the multiple segments of strip spacers are arranged as two ring structures, the ring gap is formed between the two ring structures so that the third ring spacer 109 can be engaged in the ring gap.

By the ring engagement of the third ring spacer 109 and the fourth ring spacer 110 which are respectively provided in the first vacant region 202 and the second vacant region 204, an occurrence of relative displacement between the first substrate and the second substrate when they are curved is further avoided, thus display effect of the curved display panel is further improved.

Specifically, the first substrate 101 may be an array substrate, as shown in FIG. 5 and FIG. 6, and the first substrate 101 comprises a first base substrate 115, and gate lines 111, data lines 112, thin film transistors 113, common electrodes 114, etc. which are provided on the first base substrate 115. Since the curved display panel is generally curved in a direction of the data lines, positions of the first spacers 103 preferably correspond to positions of data lines 112 on the array substrate.

Correspondingly, the second substrate 102 may be a color filter substrate, as shown in FIG. 7 and FIG. 8, and the second substrate 102 comprises a second base substrate 118, and a black matrix 116, a color filter layer 117, etc. which are provided on the second base substrate 118. Preferably, positions of the second spacer 104 correspond to positions of the black matrix 116 on the color filter substrate.

Obviously, in the present invention, the first substrate 101 may also be a color filter substrate, the second substrate 102 may also be an array substrate, that is, when individual first spacers 103 are provided on the second substrate 102, and at least one pair of second spacers 104 are provided on the first substrate 101, the present invention can also be achieved, which will not be repeatedly described here.

In the present invention, the specific shapes of the first spacers 103 and the second spacers 104 are not limited, as long as they could make the first substrate 101 and the second substrate 102 to engage with each other. For example, the first spacers 103 and the second spacers 104 may be of a strip shape as shown in FIG. 5 and FIG. 7. Since strip spacers produce a large contact area, the first substrate 101 and the second substrate 102 can be stably fixed together, thus display effect of the curved display panel would be further improved.

Preferably, the first spacer 103 and the second spacer 104 have a longitudinal section of a trapezoid shape. The end of the first spacer 103 close to the base substrate of the first substrate 101 has a width larger than that of the end of the first spacer 103 far away from the base substrate of the first substrate 101, and the end of the second spacer 104 close to the base substrate of the second substrate 102 has a width larger than that of the end of the second spacer 104 far away from the base substrate of the second substrate 102. In the context, “longitudinal” indicates a direction perpendicular to tangential direction of the first substrate and the second substrate at the corresponding position.

It is convenient to align the first substrate 101 and the second substrate 102 to form a cell by providing the longitudinal sections of the first spacers 103 and the second spacers 104 to be of trapezoid shapes. For example, as shown in FIG. 4, an opening of the gap between each pair of second spacers 104 is large at the entrance, and becomes smaller when close to the base substrate of the second substrate 102. Correspondingly, the top of the first spacer 103 is narrow and convenient to be inserted into the gap, and the first spacer 103 becomes wider from the top to the position close to the base substrate of the first substrate 101, thus the first spacer 103 and the second spacers 104 at opposite sides of the first spacer 103 are engaged with each other by interaction force, so that accuracy alignment between the first substrate 101 and the second substrate 102 is maintained.

Correspondingly, both the third ring spacer 109 in the first vacant region 202 and the fourth ring spacer 110 in the second vacant 204 have a longitudinal section of trapezoid shapes, so that it is convenient to align the first substrate 101 and the second substrate 102 to form a cell. The end of the third ring spacer 109 close to the base substrate of the first substrate 101 has a width larger than that of the end of the third ring spacer 109 far away from the base substrate of the first substrate 101, and the end of the fourth ring spacer 110 close to the base substrate of the second substrate 102 has a width larger than that of the end of the fourth ring spacer 110 far away from the base substrate of the second substrate 102.

The present invention also provides a manufacturing method of a curved display panel, comprising steps of:

preparing a first substrate, which includes:
providing a first base substrate;
arranging a plurality of first spacers on the first base substrate;

preparing a second substrate, which includes:
providing a second base substrate;
arranging a plurality of second spacer groups respectively corresponding to the first spacers on the second base substrate, wherein each of the second spacer groups includes at least one pair of second spacers, and a gap is formed between each pair of second spacers;

aligning the first substrate and the second substrate to form a cell, wherein each of the first spacers is engaged in the gap between the corresponding pair of second spacers, so that accurate alignment between the first substrate and the second substrate is maintained.

In the present invention, by arranging engaged spacers respectively on the first substrate and the second substrate, an occurrence of relative displacement between the first substrate and the second substrate when the first substrate and the second substrate are curved is effectively avoided, thus problems of light leakage and color bias caused by misalignment between the first substrate and the second substrate are avoided.

Further, the first substrate includes a first display region and a first vacant region located at periphery of the first display region, and the second substrate includes a second display region and a second vacant region located at periphery of the second display region, wherein the first spacers are arranged in the first display region, and the second spacer groups are arranged in the second display region;

the step of preparing a first substrate further includes:
arranging a third ring spacer at a position of the first base substrate corresponding to the first vacant region, wherein the third ring spacer surrounds the first display region;

the step of preparing a second substrate further includes:
arranging a fourth ring spacer at a position of the second base substrate corresponding to the second vacant region, wherein the fourth ring spacer surrounds the second display region, and a ring gap is formed in the fourth ring spacer;

the step of aligning the first substrate and the second substrate to form a cell further includes:
making the third ring spacer to be engaged in the ring gap of the fourth spacer, so that accuracy alignment between the first substrate and the second substrate is maintained.

Preferably, the fourth ring spacer is configured to include two ring spacers, and the ring gap is formed between the two ring spacers.

By the ring engagement of the third ring spacer and the fourth ring spacer which are respectively provided in the first vacant region and the second vacant region, an occurrence of relative displacement between the first substrate and the second substrate when they are curved is further avoided, thus problems of light leakage and color bias caused by misalignment is avoided, and display effect of the curved display panel is further improved.

FIG. 9 shows a section view of the first substrate and the second substrate after they are aligned to form a cell and before they are curved. As above, longitudinal sections of the first spacers, the second spacers, the third ring spacer and the fourth ring spacer are preferably of trapezoid shapes. Thus the first spacers, the second spacer groups, the third ring spacer and the fourth ring spacer may be formed synchronously by using a half-tone mask process. During aligning the first substrate and the second substrate to form a cell, the first spacers and the corresponding second spacer groups cooperate with each other, the third ring spacer and the fourth ring spacer cooperate with each other, so that there is no relative displacement between the first substrate and the second substrate when they are curved, thus problems of light leakage and color bias caused by misalignment is avoided, the display effect of the curved display panel is improved.

Preferably, the first substrate is an array substrate, and before arranging the plurality of the first spacers, the step of preparing a first substrate further includes:
forming an array of thin film transistors, gate lines and data lines, wherein the first spacers are arranged at positions corresponding to that of the data lines;

the second substrate is a color filter substrate, and before arranging the plurality of the second spacer groups, the step of preparing a second substrate further includes:
forming a black matrix and a color filter layer on the second base substrate, wherein the second spacer groups are arranged at positions corresponding to that of the black matrix.

In the present invention, the first substrate may also be a color filter substrate, the second substrate may also be an array substrate, that is, when individual first spacers are provided on the second substrate, and at least one pair of second spacers are provided on the first substrate, the present invention can also be achieved, which will not be repeatedly described here.

It should be understood that, the above implementations are only exemplified to explain the principle of the present invention, but not to limit the present invention. A person skilled in the art can make various variations and modifications without departing from spirit and scope of the present invention, and the variations and the modifications are also considered to be within the protection scope of the present invention.

1. A curved display panel, comprising a first substrate and a second substrate which are aligned to form a cell, wherein, a plurality of first spacers are arranged on the first substrate, a plurality of second spacer groups respectively corresponding to the first spacers are arranged on the second substrate, each of the second spacer groups includes at least one pair of second spacers, a gap is formed between each pair of second spacers, and each of the first spacers is engaged in the gap between the corresponding pair of second spacers so that accurate alignment between the first substrate and the second substrate is maintained.

2. The curved display panel of claim 1, wherein, the first substrate includes a first display region and a first vacant region located at periphery of the first display region, and the second substrate includes a second display region and a second vacant region located at periphery of the second display region, with the first spacers being arranged in the first display region, and the second spacer groups being arranged in the second display region; and,
wherein a third ring spacer surrounding the first display region is arranged in the first vacant region, a fourth ring spacer surrounding the second display region is arranged in the second vacant region, a ring gap is formed in the fourth ring spacer, and the third ring spacer is engaged in the ring gap of the fourth ring spacer so that accuracy alignment between the first substrate and the second substrate is maintained.

3. The curved display panel of claim 2, wherein, the fourth ring spacer is configured to include two ring spacers, and the ring gap is formed between the two ring spacers of the fourth ring spacer.

4. The curved display panel of claim 3, wherein, the third ring spacer and the fourth ring spacer have a longitudinal section of trapezoid shapes, an end of the third ring spacer close to a base substrate of the first substrate has a width larger than that of an end of the third ring spacer far away from the base substrate of the first substrate, and an end of the fourth ring spacer close to a base substrate of the second substrate has a width larger than that of an end of the fourth ring spacer far away from the base substrate of the second substrate.

5. The curved display panel of claim 1, wherein, the first spacer and the second spacer have a longitudinal section of trapezoid shapes, an end of the first spacer close to a base substrate of the first substrate has a width larger than that of an end of the first spacer far away from the base substrate of the first substrate, an end of the second spacer close to a base substrate of the second substrate has a width larger than that of an end of the second spacer far away from the base substrate of the second substrate.

6. The curved display panel of claim 1, wherein, the first substrate is an array substrate, and positions of the first spacers correspond to positions of data lines on the array substrate, the second substrate is a color filter substrate, and positions of the second spacer groups correspond to positions of a black matrix on the color filter substrate.

7. The curved display panel of claim 2, wherein, the first substrate is an array substrate, and positions of the first spacers correspond to positions of data lines on the array substrate, the second substrate is a color filter substrate, and positions of the second spacer groups correspond to positions of a black matrix on the color filter substrate.

8. The curved display panel of claim 3, wherein, the first substrate is an array substrate, and positions of the first spacers correspond to positions of data lines on the array substrate, the second substrate is a color filter substrate, and positions of the second spacer groups correspond to positions of a black matrix on the color filter substrate.

9. The curved display panel of claim 4, wherein, the first substrate is an array substrate, and positions of the first spacers correspond to positions of data lines on the array substrate, the second substrate is a color filter substrate, and positions of the second spacer groups correspond to positions of a black matrix on the color filter substrate.

10. The curved display panel of claim 5, wherein, the first substrate is an array substrate, and positions of the first spacers correspond to positions of data lines on the array substrate, the second substrate is a color filter substrate, and positions of the second spacer groups correspond to positions of a black matrix on the color filter substrate.

11. A manufacturing method of a curved display panel, comprising steps of:
preparing a first substrate, which includes:
providing a first base substrate;
arranging a plurality of first spacers on the first base substrate;
preparing a second substrate, which includes:
providing a second base substrate;
arranging a plurality of second spacer groups respectively corresponding to the first spacers on the second base substrate, wherein each of the second spacer groups includes at least one pair of second spacers, and a gap is formed between each pair of second spacers;
aligning the first substrate and the second substrate to form a cell, wherein each of the first spacers is engaged in the gap between the corresponding pair of second spacers, so that accurate alignment between the first substrate and the second substrate is maintained.

12. The manufacturing method of claim 11, wherein, the first substrate includes a first display region and a first vacant region located at periphery of the first display region, and the second substrate includes a second display region and a second vacant region located at periphery of the second display region, wherein the first spacers are arranged in the first display region, the second spacer groups are arranged in the second display region;
the step of preparing a first substrate further includes:
arranging a third ring spacer at a position of the first base substrate corresponding to the first vacant region, wherein the third ring spacer surrounds the first display region;
the step of preparing a second substrate further includes:
arranging a fourth ring spacer at a position of the second base substrate corresponding to the second vacant region, wherein the fourth ring spacer surrounds the second display region, and a ring gap is formed in the fourth ring spacer;
the step of aligning the first substrate and the second substrate to form a cell further includes:
making the third ring spacer to be engaged in the ring gap of the fourth ring spacer, so that accuracy alignment between the first substrate and the second substrate is maintained.

13. The manufacturing method of claim 12, wherein, the first spacers, the second spacer groups, the third ring spacer and the fourth ring spacer are formed synchronously by using a half-tone mask process.

14. The manufacturing method of claim 11, wherein,
the first substrate is an array substrate, and before arranging the plurality of the first spacers, the step of preparing a first substrate further includes:
forming an array of thin film transistors, gate line and data lines, wherein the first spacers are arranged at positions corresponding to that of the data lines;
the second substrate is a color filter substrate, and before arranging the plurality of the second spacer groups, the step of preparing a second substrate further includes:
forming a black matrix and a color filter layer on the second base substrate, wherein the second spacer groups are arranged at positions corresponding to that of the black matrix.

15. The manufacturing method of claim 12, wherein,
the first substrate is an array substrate, and before arranging the plurality of the first spacers, the step of preparing a first substrate further includes:
forming an array of thin film transistors, gate lines and data lines, wherein the first spacers are arranged at positions corresponding to that of the data lines;
the second substrate is a color filter substrate, and before arranging the plurality of the second spacer groups, the step of preparing a second substrate further includes:
forming a black matrix and a color filter layer on the second base substrate, wherein the second spacer groups are arranged at positions corresponding to that of the black matrix.

16. The manufacturing method of claim 13, wherein,
the first substrate is an array substrate, and before arranging the plurality of the first spacers, the step of preparing a first substrate further includes:
forming an array of thin film transistors, gate lines and data lines, wherein the first spacers are arranged at positions corresponding to that of the data lines;
the second substrate is a color filter substrate, and before arranging the plurality of the second spacer groups, the step of preparing a second substrate further includes:
forming a black matrix and a color filter layer on the second base substrate, wherein the second spacer groups are arranged at positions corresponding to that of the black matrix.
